(19) United States
(12) Patent Application Publication
(10) Pub. No.: US 2013/0233838 A1
(43) Pub. Date: Sep. 12, 2013

(54) Apparatus and method for monitoring resistance welding and system thereof

(71) Applicants: Jae Eun Kim, Ulsan (KR); Sang Su Ha, Ulsan (KR)

(72) Inventors: Jae Eun Kim, Ulsan (KR); Sang Su Ha, Ulsan (KR)

(21) Appl. No.: 13/603,695

(22) Filed: Sep. 5, 2012

(30) Foreign Application Priority Data
Mar. 7, 2012 (KR) 10-2012-0023357

(51) Int. Cl. B23K 9/10

(52) U.S. Cl. 219/130.01

(57) ABSTRACT

A method for monitoring resistance welding is provided, which includes receiving an input of waveform data obtained by converting current or voltage applied to a transformer welding gun into a digital signal through a teaching group filter; comparing the input waveform data with acceptance waveform data of current or voltage that is accumulatively stored through a destructive test; determining acceptance of a quality of a corresponding welding product if the input waveform data and the acceptance waveform data are equal or similar to each other within a predetermined error range, and determining rejection of the quality of the corresponding welding product if the input waveform data and the acceptance waveform data are different from each other; and outputting an acceptance or rejection message depending on the result of the determination.

### CROSS-REFERENCE TO RELATED APPLICATION

This application is based on and claims priority from Korean Patent Application No. 10-2012-0023357, filed on Mar. 7, 2012 in the Korean Intellectual Property Office, the disclosure of which is incorporated herein in its entirety by reference.

### BACKGROUND OF THE INVENTION

1. Field of the invention

The present invention relates to an apparatus and a method for monitoring resistance welding and a system thereof, and more particularly, to an apparatus and a method for monitoring resistance welding and a system thereof, in which waveform data obtained by converting current or voltage that is applied to a welding gun of a transformer into a digital signal is compared with corresponding acceptance waveform data that is accumulatively stored through a destructive test, acceptance or rejection of a quality of a corresponding welding product is determined depending on the result of the comparison, and a corresponding acceptance or rejection message is displayed to notify a user of the message.

2. Description of the Prior Art

In general, resistance welding means an engineering method in which heat is generated through contact resistance that occurs on contact surfaces of metals and specific resistance of the metal by making large current flow in a compressed state, and the metals are joined by an applied pressure when the metals are heated or melted due to the generated heat.

The resistance welding is classified into spot welding and projection welding. In the spot welding, current density is heightened depending on the shape of an electrode tip, and in the projection welding, current density is heightened depending on the shape of a welded material.

A non-destructive testing device for the spot welding in the related art may be an ultrasonic inspection device, in which if a measurer directly makes a probe that generates ultrasonic waves in contact with a spot welding portion, an ultrasonic pattern is output to a monitor by the ultrasonic waves generated from the probe, and a skilled expert determines whether the welding is inferior or not by analyzing the ultrasonic pattern output to the monitor.

However, the non-destructive testing device in the related art as described above has the problem that since the ultrasonic inspection device is used, only a skilled expert can analyze the ultrasonic pattern, but a non-skilled person is unable to use the ultrasonic inspection device.

Further, since the position, pressure, and contact characteristics of the probe exert an influence on the pattern change, different results are obtained depending on the proficiency of the measurer, and thus it is difficult to accurately grasp the welding inferiority.

### SUMMARY OF THE INVENTION

Accordingly, the present invention has been made to solve the above-mentioned problems occurring in the related art while advantages achieved by the related art are maintained intact.

One subject to be achieved by the present invention is to provide an apparatus and a method for monitoring resistance welding and a system thereof, which can automatically and accurately grasp welding inferiority using simple existing equipment regardless of measurer's proficiency, reduce welding inferiority testing time, and heighten and adjust reliability in a teaching range.

In one embodiment of the present invention, there is provided a method for monitoring resistance welding, which includes an input step of receiving an input of waveform data obtained by converting current or voltage that is applied to a transformer welding gun into a digital signal through a teaching group filter; a first comparison step of comparing the input waveform data with acceptance waveform data of current or voltage that is accumulatively stored through a destructive test; a first determination step of determining acceptance of a quality of a corresponding welding product if the input waveform data and the corresponding acceptance waveform data are equal or similar to each other within a predetermined error range, and determining rejection of the quality of the corresponding welding product if the input waveform data and the corresponding acceptance waveform data are different from each other to exceed the predetermined error range; and a message output step of outputting an acceptance or rejection message depending on the result of the determination in the first determination step to notify a user of the acceptance or rejection message.

Preferably, the method for monitoring resistance welding according to the embodiment of the present invention may further include a second comparison step of calculating resistance or a heat amount from the input waveform data, converting the calculated resistance or the heat amount into a digital signal, and comparing waveform data of the resistance or the heat amount obtained by conversion into the digital signal with acceptance waveform data of the resistance or the heat amount that is accumulatively stored through the destructive test; and a second determination step of determining acceptance or rejection of the quality of the corresponding welding product using the result of the comparison in the second comparison step and the result of the comparison in the first comparison step.

The method for monitoring resistance welding according to the embodiment of the present invention may further include individually determining the acceptance of the quality of the corresponding welding product if any one of the waveform data of the current, the voltage, the resistance, and the heat amount is equal or similar to the corresponding acceptance waveform data within the predetermined error range, and integrally determining the acceptance of the quality of the corresponding welding product if all the waveform data of the current, the voltage, the resistance, and the heat amount are equal or similar to the corresponding acceptance waveform data within the predetermined error range.

In another embodiment of the present invention, there is provided an apparatus for monitoring resistance welding, which includes an interface module receiving an input of waveform data obtained by converting current or voltage that is applied to a transformer welding gun into a digital signal; a first comparison unit comparing the input waveform data with acceptance waveform data of current or voltage that is accumulatively stored through a destructive test; a first determination unit determining acceptance of a quality of a corresponding welding product if the input waveform data and the corresponding acceptance waveform data are equal or similar to each other within a predetermined error range, and determining rejection of the quality of the corresponding welding product if the input waveform data and the corresponding acceptance waveform data are different from each other to exceed the predetermined error range, as the result of the comparison by the first comparison unit; and a message output module outputting an acceptance or rejection message depending on the result of the determination by the first determination unit to notify a user of the acceptance or rejection message.

Preferably, the apparatus for monitoring resistance welding according to the embodiment of the present invention may further include a second comparison unit calculating resistance or a heat amount from the input waveform data, converting the calculated resistance or heat amount into a digital signal, and comparing waveform data of the resistance or the heat amount obtained by conversion into the digital signal with acceptance waveform data of the resistance or the heat amount that is accumulatively stored through the destructive test; and a second determination unit determining acceptance or rejection of the quality of the corresponding welding product using the result of the comparison by the second comparison unit and the result of the comparison by the first comparison unit.

In the apparatus for monitoring resistance welding according to the embodiment of the present invention, the second determination unit may individually determine the acceptance of the quality of the corresponding welding product if any one of the waveform data of the current, the voltage, the resistance, and the heat amount is equal or similar to the corresponding acceptance waveform data within the predetermined error range, and may integrally determine the acceptance of the quality of the corresponding welding product if all the waveform data of the current, the voltage, the resistance, and the heat amount are equal or similar to the corresponding acceptance waveform data within the predetermined error range as the results of the comparison by the first and second comparison units.

In still another embodiment of the present invention, there is provided a system for monitoring resistance welding, which includes a sensor unit sensing current or voltage that is applied to a transformer welding gun; a timer converting the current or the voltage sensed by the sensor unit into a digital signal; and a teaching group filter receiving an input of waveform data, which is obtained by converting the current or the voltage into the digital signal, from the timer, comparing the input waveform data with acceptance waveform data of the current or the voltage that is accumulatively stored through a destructive test, determining acceptance of a quality of a corresponding welding product if the input waveform data and the corresponding acceptance waveform data are equal or similar to each other within a predetermined error range and determining rejection of the quality of the corresponding welding product if the input waveform data and the corresponding acceptance waveform data are different from each other to exceed the predetermined error range as the result of the comparison, and outputting an acceptance or rejection message depending on the result of the determination depending on the result of the determination to notify a user of the acceptance or rejection message.

Preferably, in the system for monitoring resistance welding according to the embodiment of the present invention, the teaching group filter may calculate resistance or a heat amount from the input waveform data, convert the calculated resistance or heat amount into a digital signal, compare waveform data of the resistance or the heat amount obtained by conversion into the digital signal with acceptance waveform data of the resistance or the heat amount that is accumulatively stored through the destructive test, and determine acceptance or rejection of the quality of the corresponding welding product using the results of the comparison.

In the system for monitoring resistance welding according to the embodiment of the present invention, the teaching group filter may individually determine the acceptance of the quality of the corresponding welding product if any one of the waveform data of the current, the voltage, the resistance, and the heat amount is equal or similar to the corresponding acceptance waveform data within the predetermined error range, and may integrally determine the acceptance of the quality of the corresponding welding product if all the waveform data of the current, the voltage, the resistance, and the heat amount are equal or similar to the corresponding acceptance waveform data within the predetermined error range.

According to the present invention, the waveform data obtained by converting the current or the voltage that is applied to the welding gun of the transformer into the digital signal is compared with the corresponding acceptance waveform data that is accumulatively stored through the destructive test, the acceptance or the rejection of the quality of the corresponding welding product is determined depending on the result of the comparison, and the corresponding acceptance or rejection message is displayed to notify the user of the message. Accordingly, the welding inferiority can automatically and accurately be grasped using the simple existing equipment regardless of the measurer's proficiency, the welding inferiority testing time can be reduced, and the reliability can be heightened and adjusted within the teaching range.

For reference, the results of comparison between the resistance welding method in the related art (for example, destructive testing method and ultrasonic non-destructive manual test) and the present invention (system for monitoring resistance welding) are described in Table 1 below.

TABLE 1

| | Destructive testing | Ultrasonic non-destructive | System for monitoring |
|---|---|---|---|
| Classification | method | manual test | resistance welding |
| Personnel | Personnel fixed, | Automation line | Necessary during reliability |
| | Two shifts | inapplicable | verification |
| Test | 5 to 20 welding points | Automation line | Vehicle routine test |
| specimens | per vehicle body | inapplicable | Product mixing line usable |
| | (1000 points basis) | | |
| Proficiency | None | Technical education and | Applicable after four-hour |
| | | technical skills | education |
| Testing time | 5 to 10 seconds per | 3 to 60 seconds per | 60 seconds or less for 100 |
| | welding point | welding point | welding points |
| Equipment | Hammer, chisel | Ultrasonic equipment | Existing network equipment |
| | | | and PC |
| Reliability | 100% | Different depending on | Reliability adjustable in |
| | | proficiency | teaching range (maximum of |
| | | | 98%) |

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a system for monitoring resistance welding according to an embodiment of the present invention;

FIG. 2 is a block diagram illustrating the detailed configuration of a teaching group filter according to an embodiment of the present invention;

FIGS. 3A and 3B are flowcharts illustrating a method for monitoring resistance welding according to an embodiment of the present invention; and

FIGS. 4A to 4E are diagrams illustrating examples of setting states of an acceptance resistance range according to the present invention.

### DETAILED DESCRIPTION OF THE PREFERRED EMBODIMENTS

Hereinafter, a preferred embodiment of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

In order to clearly explain the present invention, description of portions that are not related to the explanation will be omitted. In the entire description of the present invention, the same drawing reference numerals are used for the same elements across various figures.

In the whole description and claims, the term “comprises” and/or “comprising” means that one or more other components, steps, operation and/or existence or addition of elements are not excluded in addition to the described components, steps, operation and/or elements.

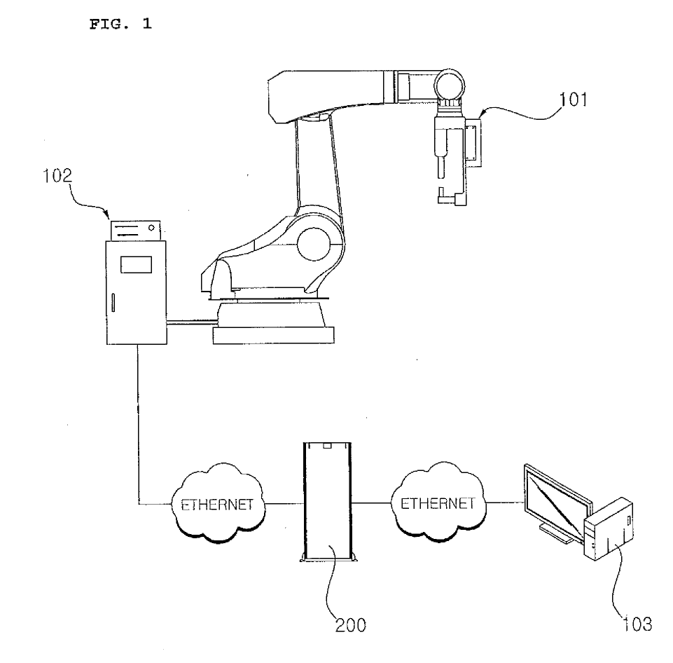

FIG. 1 is a diagram illustrating a system for monitoring resistance welding according to an embodiment of the present invention.

As illustrated in FIG. 1, the system for monitoring resistance welding according to an embodiment of the present invention is configured to include a sensor unit (not illustrated) built in a transformer 101, a timer 102, a teaching group filter 200, and a client monitor 103.

That is, the system for monitoring resistance welding includes the sensor unit sensing current or voltage that is applied to a transformer welding gun; the timer 102 converting the current or the voltage sensed by the sensor unit into a digital signal; the teaching group filter 200 receiving an input of waveform data, which is obtained by converting the current or the voltage into the digital signal, from the timer 102, comparing the input waveform data with acceptance waveform data of the current or the voltage that is accumulatively stored through a destructive test, determining acceptance of a quality of a corresponding welding product if the input waveform data and the corresponding acceptance waveform data are equal or similar to each other within a predetermined error range and determining rejection of the quality of the corresponding welding product if the input waveform data and the corresponding acceptance waveform data are different from each other to exceed the predetermined error range as the result of the comparison, and outputting an acceptance or rejection message depending on the result of the determination depending on the result of the determination to notify a user of the acceptance or rejection message; and the client monitor 103 displaying the acceptance or rejection message output from the teaching group filter 200 on a screen to notify the user of the acceptance or rejection message.

Here, the transformer 101 includes a temperature sensor for intelligent control, a voltage/current sensor, and a 6P signal connector, which are built therein. Specifically, the voltage/current sensor senses current or voltage that is applied to a welding gun of the transformer 101 and transmits the sensed current or voltage to the timer 102. According to the welding condition input from the timer 102, the welding is performed at an end portion of a robot.

The timer 102 receives the current or voltage which is applied to the welding gun of the transformer 101 and which is sensed by the sensor unit (for example, current/voltage sensor) built in the transformer 101, converts the input current or voltage into a digital signal, and transmits the digital signal to the teaching group filter 200 through an Ethernet network. For reference, since the system receives in real time a feedback of the current and voltage during the resistance welding and monitors in real time the change of the dynamic resistance, the system can perform an active control with respect to external conditions being changed. The real-time current/voltage monitoring is performed as the monitoring of the dynamic resistance by measuring the current in the transformer and measuring the voltage at an output end of the transformer.

The teaching group filter 200 receives the input of the waveform data, which is obtained by converting the current or the voltage into the digital signal, from the timer 102, compares the input waveform data with the acceptance waveform data of the current or the voltage that is accumulatively stored through the destructive test, determines the acceptance or the rejection of the quality of the corresponding welding product depending on the result of the comparison, and outputs the acceptance or rejection message to the client monitor 103 depending on the result of the determination. For example, if the input waveform data and the corresponding acceptance waveform data are equal or similar to each other within the predetermined error range, the teaching group filter 200 determines the acceptance of the quality of the corresponding welding product, and if the input waveform data and the corresponding acceptance waveform data are different from each other to exceed the predetermined error range as the result of the comparison, the teaching group filter 200 determines the rejection of the quality of the corresponding welding product. The teaching group filter 200 outputs the message that corresponds to the result of the determination to the client monitor 103. On the other hand, the teaching group filter 200 calculates resistance or a heat amount from the input waveform data, converts the calculated resistance or heat amount into a digital signal, compares waveform data of the resistance or the heat amount obtained by conversion into the digital signal with acceptance waveform data of the resistance or the heat amount that is accumulatively stored through the destructive test, and determines the acceptance or rejection of the quality of the corresponding welding product using the results of the comparison. In this case, the teaching group filter 200 individually determines the acceptance of the quality of the corresponding welding product if any one of the waveform data of the current, the voltage, the resistance, and the heat amount is equal or similar to the corresponding acceptance waveform data within the predetermined error range, and integrally determines the acceptance of the quality of the corresponding welding product if all the waveform data of the current, the voltage, the resistance, and the heat amount are equal or similar to the corresponding acceptance waveform data within the predetermined error range. The result of the determination is transmitted to the client monitor 103 in the form of a message.

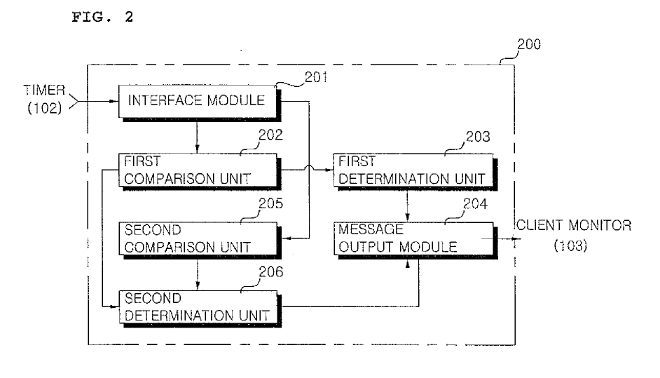

Hereinafter, the teaching group filter that constitutes the system for monitoring resistance welding according to an embodiment of the present invention of FIG. 1 will be described in more detail with reference to FIG. 2.

FIG. 2 is a block diagram illustrating the detailed configuration of a teaching group filter according to an embodiment of the present invention.

As illustrated in FIG. 2, the teaching group filter according to an embodiment of the present invention is configured to include an interface module 201, a first comparison unit 202, a first determination unit 203, and a message output module 204.

That is, the teaching group filter includes the interface module 201 receiving an input of waveform data obtained by converting current or voltage that is applied to a transformer welding gun into a digital signal from the timer 102 through an Ethernet network; the first comparison unit 202 comparing the input waveform data with acceptance waveform data of current or voltage that is accumulatively stored through a destructive test; the first determination unit 203 determining acceptance of a quality of a corresponding welding product if the input waveform data and the corresponding acceptance waveform data are equal or similar to each other within a predetermined error range, and determining rejection of the quality of the corresponding welding product if the input waveform data and the corresponding acceptance waveform data are different from each other to exceed the predetermined error range, as the result of the comparison by the first comparison unit 202; and the message output module 204 outputting an acceptance or rejection message depending on the result of the determination by the first determination unit 203 to notify a user of the acceptance or rejection message.

In addition, the teaching group filter further includes a second comparison unit 205 and a second determination unit 206.

Here, the interface module 201 accesses the timer 102 through the Ethernet network, and receives the input of the data output by the timer 102, that is, the input of the waveform data obtained by converting the current or the voltage that is applied to the transformer welding gun into the digital signal through an Ethernet network.

The first comparison unit 202 compares the waveform data of the current or the voltage input by the interface module with the acceptance waveform data of the current or the voltage that is accumulatively stored through the destructive test.

The first determination unit 203 determines the acceptance of the quality of the corresponding welding product if the input waveform data of the current or the voltage and the corresponding acceptance waveform data are equal or similar to each other within the predetermined error range, and determines the rejection of the quality of the corresponding welding product if the input waveform data of the current of the voltage and the corresponding acceptance waveform data are different from each other to exceed the predetermined error range, as the result of the comparison by the first comparison unit 202.

The message output module 204 is connected to the client monitor 103 through the Ethernet network, and outputs the acceptance or rejection message depending on the result of the determination by the first determination unit 203 to notify a user of the acceptance or rejection message.

The second comparison unit 206 calculates the resistance or the heat amount from the input waveform data, converts the calculated resistance or the heat amount into the digital signal, and compares the waveform data of the resistance or the heat amount obtained by conversion into the digital signal with the acceptance waveform data of the resistance or the heat amount that is accumulatively stored through the destructive test.

The second determination unit 206 determines the acceptance or the rejection of the quality of the corresponding welding product using the result of the comparison by the second comparison unit 205 and the result of the comparison by the first comparison unit 202. For example, the second determination unit 206 individually determines the acceptance of the quality of the corresponding welding product if any one of the waveform data of the current, the voltage, the resistance, and the heat amount is equal or similar to the corresponding acceptance waveform data within the predetermined error range, and integrally determines the acceptance of the quality of the corresponding welding product if all the waveform data of the current, the voltage, the resistance, and the heat amount are equal or similar to the corresponding acceptance waveform data within the predetermined error range as the results of the comparison by the first and second comparison units 202 and 205.

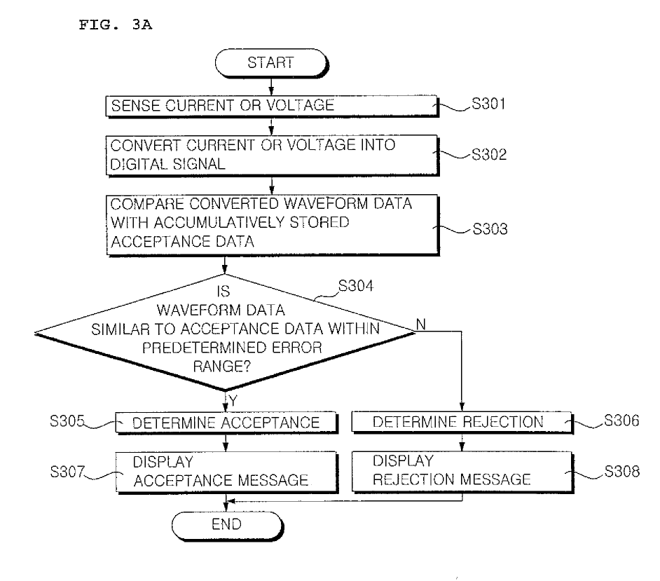

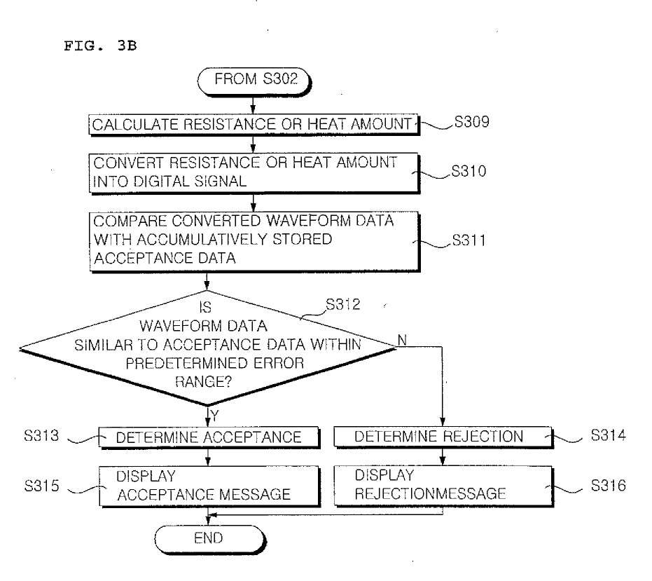

Hereinafter, the operation of the system for monitoring resistance welding according to an embodiment of the present invention of FIG. 1 will be described with reference to FIGS. 3A and 3B.

FIGS. 3A and 3B are diagrams sequentially illustrating the operation of the system for monitoring resistance welding according to an embodiment of the present invention.

As illustrated in FIG. 3A, current of voltage that is applied to a welding gun of a transformer is first sensed (S301).

The sensing operation is performed through a voltage or current sensor built in the transformer.

Next, a timer converts the sensed current or voltage that is applied to the welding gun of the transformer into a digital signal (S302).

Then, the digital signal is transmitted to a teaching group filter through an Ethernet network.

Next, the teaching group filter receives an input of waveform data obtained by converting the current or the voltage into the digital signal from the timer, and compares the input waveform data with acceptance waveform data of the current or the voltage that is accumulatively stored through a destructive test (S303).

Then, the teaching group filter determines acceptance or rejection of a quality of a corresponding welding product and outputs an acceptance or rejection message to a client monitor depending on the result of the determination.

For example, if the input waveform data of the current or the voltage and the corresponding acceptance waveform data are equal or similar to each other within a predetermined error range, the teaching group filter determines the acceptance of the quality of the corresponding welding product, and outputs the acceptance message that corresponds to the result of the determination to the client monitor.

If the input waveform data and the corresponding acceptance waveform data are different from each other to exceed the predetermined error range, the teaching group filter determines the rejection of the quality of the corresponding welding product, and outputs the rejection message that corresponds to the result of the determination to the client monitor (S304 to S308).

The acceptance or rejection message output as above is displayed through the client monitor to notify a user of the acceptance or the rejection of the quality of the corresponding welding product.

On the other hand, as illustrated in FIG. 3B, the teaching group filter calculates resistance or a heat amount from the input waveform data, converts the calculated resistance or heat amount into a digital signal, compares waveform data of the resistance or the heat amount obtained by conversion into the digital signal with acceptance waveform data of the resistance or the heat amount that is accumulatively stored through the destructive test, and determines the acceptance or rejection of the quality of the corresponding welding product using the results of the comparison.

In this case, the teaching group filter individually determines the acceptance of the quality of the corresponding welding product if any one of the waveform data of the current, the voltage, the resistance, and the heat amount is equal or similar to the corresponding acceptance waveform data within the predetermined error range, and integrally determines the acceptance of the quality of the corresponding welding product, if all the waveform data of the current, the voltage, the resistance, and the heat amount are equal or similar to the corresponding acceptance waveform data within the predetermined error range (S309 to S316). The result of the determination is transmitted to the client monitor 103 in the form of a message.

As described above, according to the present invention, the waveform data obtained by converting the current or the voltage that is applied to the welding gun of the transformer into the digital signal is compared with the corresponding acceptance waveform data that is accumulatively stored through the destructive test, the acceptance or the rejection of the quality of the corresponding welding product is determined depending on the result of the comparison, and the corresponding acceptance or rejection message is displayed to notify the user of the message. Accordingly, the welding inferiority can automatically and accurately be grasped using the simple existing equipment regardless of the measurer's proficiency, the welding inferiority testing time can be reduced, and the reliability can be heightened and adjusted within the teaching range.

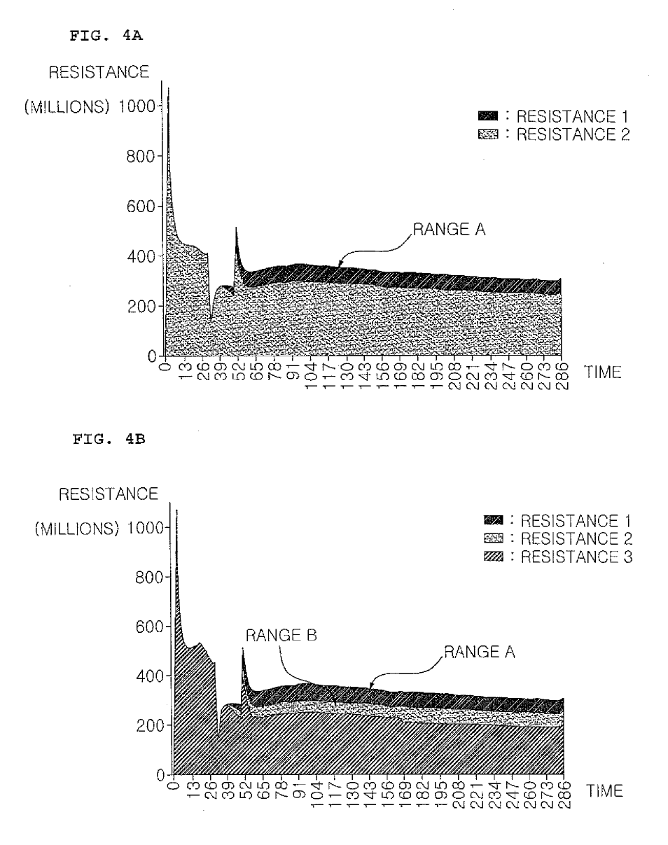

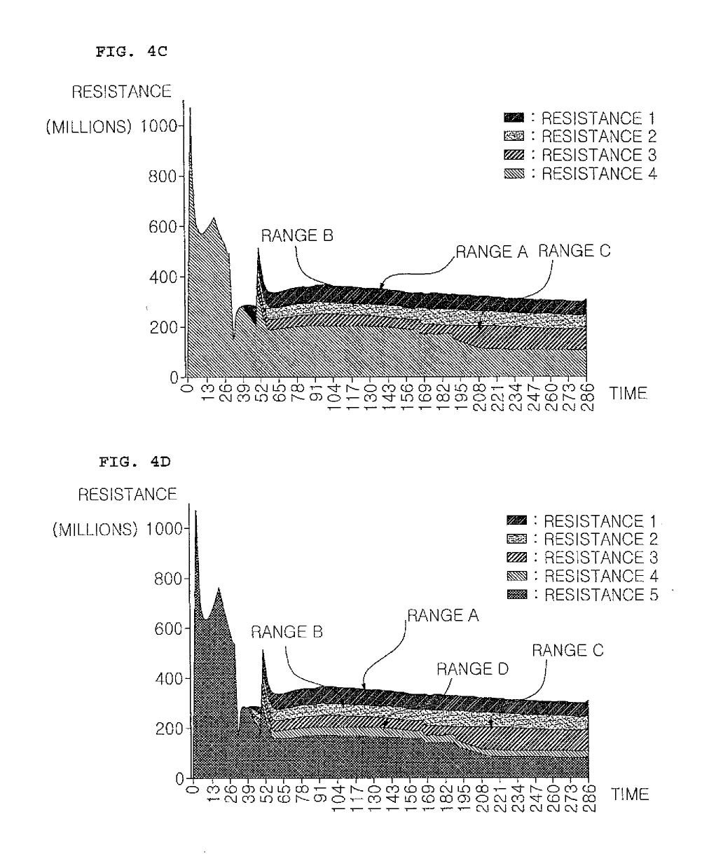

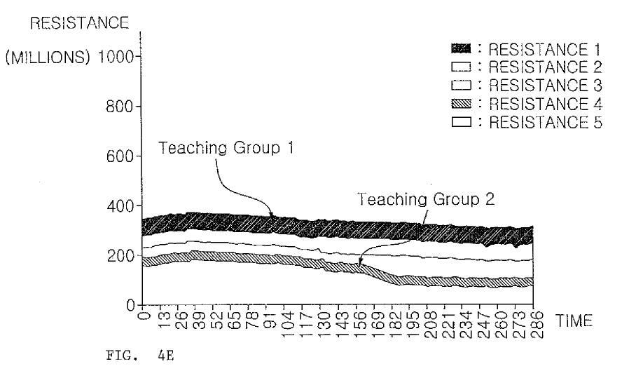

FIGS. 4A to 4E are diagrams sequentially illustrating examples of setting states of an acceptance resistance range according to the present invention.

First, a destructive test has been made with respect to a welding product having measured resistance 1 and a welding product having measured resistance 2. If the acceptance is determined, the acceptance resistance range is set as teaching (FIG. 4A). By contrast, if the rejection is determined through the destructive test of a welding product having measured resistance 3, only the existing range A is set as the acceptance resistance range without teaching, but the range B is not set as the acceptance resistance range (FIG. 4B). Next, if the acceptance is determined through the destructive test of a welding product having measured resistance 4, all the ranges A, B, and C may be set as the acceptance resistance range. However, since the rejection is determined with respect to the welding product having measured resistance 3, the ranges B and C are not set as the acceptance resistance range (FIG. 4C). Then, if the acceptance is determined through the destructive test of a welding product having measured resistance 5, the range A is set to a first group and the range D is set to a second group as the acceptance resistance range, but the ranges B and C are not included in the acceptance resistance range (FIG. 4D). Through such repeated teaching, the acceptance resistance range can be set in detail (FIG. 4E).

Although preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for monitoring resistance welding, comprising:
an input step of receiving an input of waveform data obtained by converting current or voltage that is applied to a transformer welding gun into a digital signal through a teaching group filter;
a first comparison step of comparing the input waveform data with acceptance waveform data of current or voltage that is accumulatively stored through a destructive test;
a first determination step of determining acceptance of a quality of a corresponding welding product if the input waveform data and the corresponding acceptance waveform data are equal or similar to each other within a predetermined error range, and determining rejection of the quality of the corresponding welding product if the input waveform data and the corresponding acceptance waveform data are different from each other to exceed the predetermined error range; and
a message output step of outputting an acceptance or rejection message depending on the result of the determination in the first determination step to notify a user of the acceptance or rejection message.

2. The method for monitoring resistance welding according to claim 1, further comprising:
a second comparison step of calculating resistance or a heat amount from the input waveform data, converting the calculated resistance or the heat amount into a digital signal, and comparing waveform data of the resistance or the heat amount obtained by conversion into the digital signal with acceptance waveform data of the resistance or the heat amount that is accumulatively stored through the destructive test; and
a second determination step of determining the acceptance or rejection of the quality of the corresponding welding product using the result of the comparison in the second comparison step and the result of the comparison in the first comparison step.

3. The method for monitoring resistance welding according to claim 2, further comprising individually determining the acceptance of the quality of the corresponding welding product if any one of the waveform data of the current, the voltage, the resistance, and the heat amount is equal or similar to the corresponding acceptance waveform data within the predetermined error range, and integrally determining the acceptance of the quality of the corresponding welding product if all the waveform data of the current, the voltage, the resistance, and the heat amount are equal or similar to the corresponding acceptance waveform data within the predetermined error range.

4. An apparatus for monitoring resistance welding, comprising:
an interface module receiving an input of waveform data obtained by converting current or voltage that is applied to a transformer welding gun into a digital signal;
a first comparison unit comparing the input waveform data with acceptance waveform data of current or voltage that is accumulatively stored through a destructive test;
a first determination unit determining acceptance of a quality of a corresponding welding product if the input waveform data and the corresponding acceptance waveform data are equal or similar to each other within a predetermined error range, and determining rejection of the quality of the corresponding welding product if the input waveform data and the corresponding acceptance waveform data are different from each other to exceed the predetermined error range, as the result of the comparison by the first comparison unit; and
a message output module outputting an acceptance or rejection message depending on the result of the determination by the first determination unit to notify a user of the acceptance or rejection message.

5. The apparatus for monitoring resistance welding according to claim 4, further comprising:
a second comparison unit calculating resistance or a heat amount from the input waveform data, converting the calculated resistance or heat amount into a digital signal, and comparing waveform data of the resistance or the heat amount obtained by conversion into the digital signal with acceptance waveform data of the resistance or the heat amount that is accumulatively stored through the destructive test; and
a second determination unit determining the acceptance or rejection of the quality of the corresponding welding product using the result of the comparison by the second comparison unit and the result of the comparison by the first comparison unit.

6. The apparatus for monitoring resistance welding according to claim 5, wherein the second determination unit individually determines the acceptance of the quality of the corresponding welding product if any one of the waveform data of the current, the voltage, the resistance, and the heat amount is equal or similar to the corresponding acceptance waveform data within the predetermined error range, and integrally determines the acceptance of the quality of the corresponding welding product if all the waveform data of the current, the voltage, the resistance, and the heat amount are equal or similar to the corresponding acceptance waveform data within the predetermined error range as the results of the comparison by the first and second comparison units.

7. A system for monitoring resistance welding, comprising:
a sensor unit sensing current or voltage that is applied to a transformer welding gun;
a timer converting the current or the voltage sensed by the sensor unit into a digital signal; and
a teaching group filter receiving an input of waveform data, which is obtained by converting the current or the voltage into the digital signal, from the timer, comparing the input waveform data with acceptance waveform data of the current or the voltage that is accumulatively stored through a destructive test, determining acceptance of a quality of a corresponding welding product if the input waveform data and the corresponding acceptance waveform data are equal or similar to each other within a predetermined error range and determining rejection of the quality of the corresponding welding product if the input waveform data and the corresponding acceptance waveform data are different from each other to exceed the predetermined error range as the result of the comparison, and outputting an acceptance or rejection message depending on the result of the determination depending on the result of the determination to notify a user of the acceptance or rejection message.

8. The system for monitoring resistance welding according to claim 7, wherein the teaching group filter calculates resistance or a heat amount from the input waveform data, converts the calculated resistance or heat amount into a digital signal, compares waveform data of the resistance or the heat amount obtained by conversion into the digital signal with acceptance waveform data of the resistance or the heat amount that is accumulatively stored through the destructive test, and determines the acceptance or rejection of the quality of the corresponding welding product using the results of the comparison.

9. The system for monitoring resistance welding according to claim 8, wherein the teaching group filter individually determines the acceptance of the quality of the corresponding welding product if any one of the waveform data of the current, the voltage, the resistance, and the heat amount is equal or similar to the corresponding acceptance waveform data within the predetermined error range, and integrally determines the acceptance of the quality of the corresponding welding product if all the waveform data of the current, the voltage, the resistance, and the heat amount are equal or similar to the corresponding acceptance waveform data within the predetermined error range.
